(19) United States
(12) Patent Application Publication
(10) Pub. No.: US 2002/0179646 A1
(43) Pub. Date: Dec. 5, 2002

(54) Dispensing device for a fluid product

(75) Inventor: Ludovic Petit, Vitot (FR)

Correspondence Address: SUGHRUE MION, PLLC, 2100 Pennsylvania Avenue, NW, Washington, DC, 20037-3213, US

(73) Assignee: VALOIS S.A.

(21) Appl. No.: 10/115,012

(22) Filed: Apr. 4, 2002

Related U.S. Application Data
(60) Provisional application No. 60/291,007, filed on May 16, 2001.

(30) Foreign Application Priority Data
Apr. 4, 2001 (FR) 01.04596

(51) Int. Cl. B67D 5/64

(52) U.S. Cl. 222/173

(57) ABSTRACT

Dispensing device for a fluid product including a product tank (10) comprising a neck (11) defining an internal wall (12) and a pump (20), fixed to said neck (11) of tank (10), wherein the device includes air venting and a filter (30) for venting air, characterized in that said pump (20) includes a fixing portion (22, 25) which is fixed on the internal wall (12) of said neck (11) of tank (10), wherein said filter (30) is fixed on said fixing means (22, 25).

### CROSS REFERENCE TO RELATED APPLICATION

This application claims the benefit under 35 U.S.C. §119(e) of pending U.S. provisional patent application Serial No. 60/291,007, filed May 16, 2001, 2001, and priority under 35 U.S.C. §119(a)-(d) of French patent application No. FR-01.04596, filed Apr. 4, 2001.

### TECHNICAL FIELD

The present invention relates to a dispensing device for a fluid product.

More specifically, the invention relates to such a device including a tank, a dispensing unit for selectively dispensing the product contained in the tank, wherein the volume of product dispensed at each actuation is compensated by venting air, wherein the device comprises a filter for venting air in order to avoid any contamination of the product contained in the tank.

### BACKGROUND OF THE INVENTION

Generally, dispensing units, such as pumps or valves, are fixed to the tank through an external fixing ring which is either crimped, or snapped, or screwed onto the outside of the neck of the tank. This works satisfactorily, but it may involve a certain number of drawbacks. Thus, crimping and screwing involve the use of relatively complex mounting machines, whereas snapping on generally requires means for preventing the snapped ring from opening after its fixing. On the other hand, the use of an external ring may involve an increase in the external dimensions of the device, and this is not always satisfactory as regards its aspect, so this sometimes implies the use of an extra external trim. Further, with the use of an external fixing ring, means for retaining the dispensing head, i.e. means for preventing removal of said head, may not be made simply, this is particularly true for crimping rings which are generally metal.

Another essential aspect of the present invention, relates to the filter for venting air. Actually, in certain fields, like the pharmaceutical fields, it is very important that the product contained in the tank is not contaminated in any way, and in particular by the venting air which penetrates within the tank after each actuation of the pump or of the valve. A great number of systems for fixing a pump on a tank have been developed which integrate such a filter, wherein this system generally incorporates a fixing ring which is fixed on the outside of the neck of the tank as explained above.

The object of the present invention is to provide a dispensing device for a fluid product which does not reproduce the aforementioned drawbacks.

More specifically, the object of the present invention is to provide a dispensing device for a fluid product wherein the dispensing unit is fixed on the neck of the tank without using a fixing ring which cooperates with the outside of the neck of the tank.

The object of the present invention is also to provide such a dispensing device for a fluid product which ensures a perfect seal while guaranteeing filtering of the venting air after each actuation of the device.

The object of the present invention is also to provide a dispensing device for a fluid product which is simple and not very expensive to make and assemble.

### BRIEF SUMMARY OF THE INVENTION

In accordance with the above objects, the present invention provides a dispensing device for a fluid product including a product tank comprising a neck defining an internal wall, and a pump, fixed to said neck of tank, wherein the device includes air venting and a filter for venting air, characterized in that said pump include a fixing portion which is fixed on the internal wall of said neck of tank, wherein said filter is fixed on said fixing portion.

Advantageously, the pump includes a body comprising an upper edge which forms said fixing portion, so that said body is directly fixed onto the internal wall of neck of tank, wherein said filter is positioned between said upper edge of the body and said neck of the tank.

Advantageously, the upper edge of body is fixed, preferably snapped into a ring forming the fixing portion, wherein said ring is fixed on the internal wall of neck of tank, said filter is positioned between said upper edge of the body and said ring.

Advantageously, the fixing portion of body is tightly fitted into the neck of tank.

Advantageously, the fixing portion of body is snapped into a fixing profile provided in the internal wall of the neck of tank.

Advantageously, said fixing profile of neck of tank includes a groove or a shoulder for snapping on.

### BRIEF DESCRIPTION OF THE DRAWINGS

Other features and advantages of the present invention will appear more clearly in the following detailed description of three advantageous embodiments of the latter, made with reference to the appended drawings, given as non-limiting examples, and wherein:

FIG. 1 is a schematic transverse sectional view of a first advantageous embodiment of the present invention;

FIG. 2 is a schematic transverse sectional view of a second advantageous embodiment of the present invention; and

FIG. 3 is a schematic transverse sectional view of a third embodiment of the present invention.

### BRIEF DESCRIPTION OF THE DRAWINGS

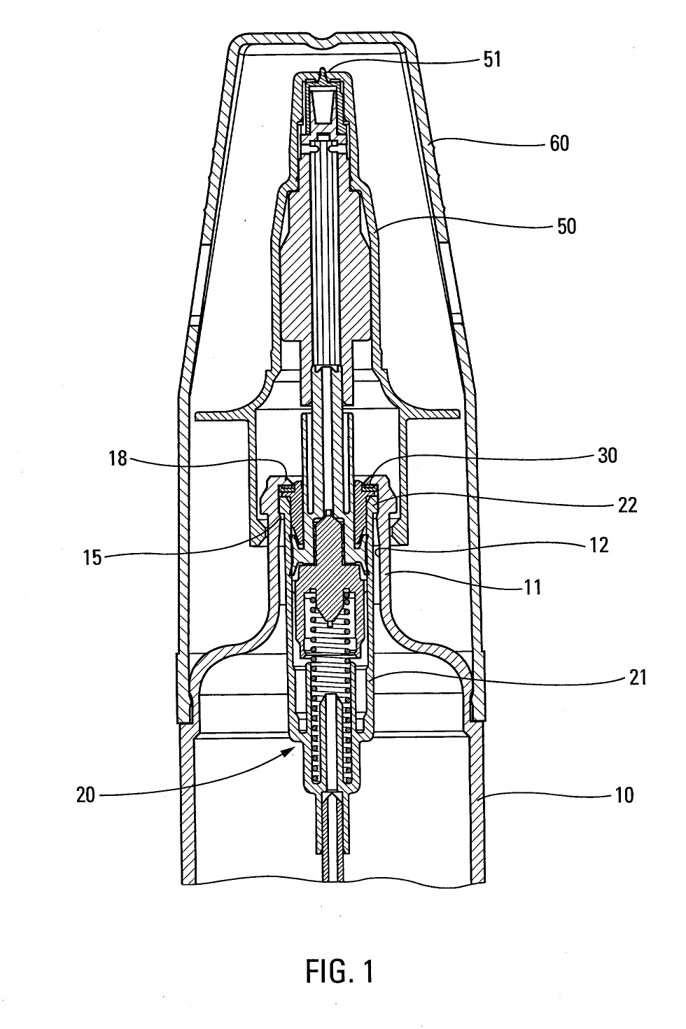

Referring to FIG. 1, a tank 10 is illustrated, including a neck 11 on which is assembled a dispensing unit 20, in this case a pump. The pump is actuated by means of a dispensing head 50 which incorporates the dispensing port 51, and a protective cap 60 may be positioned around said dispensing head when the pump is not used.

According to the invention, the distribution unit, more specifically the pump 20, includes a body 21 which defines an upper edge 22. The upper edge 22, in the example illustrated in FIG. 1, is directly fixed on the internal wall 12 of neck 11 of container 10. In this example, the internal wall 12 of neck 11 of tank 10 includes a groove 15 which enables the upper edge 22 of body 21 to be snapped into said neck. According to the invention, a filter 30 is positioned between the upper edge 22 of body 21 and neck 11 of tank 10. Advantageously, this filter 30 also acts as a neck gasket. In the example illustrated in FIG. 1, neck 11 includes an upper radial flange 18 which holds the filter 30 into place between said neck 11 and upper edge 22 of the body of the pump. In this case, the pump is assembled through the lower end of tank 10 (not shown) but it is understood that a snapping of the pump body directly into the neck of the tank may also be contemplated through the neck itself, i.e. through the upper side in FIG. 1.

In this first embodiment illustrated in FIG. 1, the upper edge 22 of the body therefore acts directly as a fixing portion for pump 20, and filter 30 is fixed on said fixing portion formed by said upper edge 22. Optionally, as illustrated in the figure, a ferrule, which is used for determining the rest position of the pump, may be inserted between the filter and the upper edge 22 of the pump body 21.

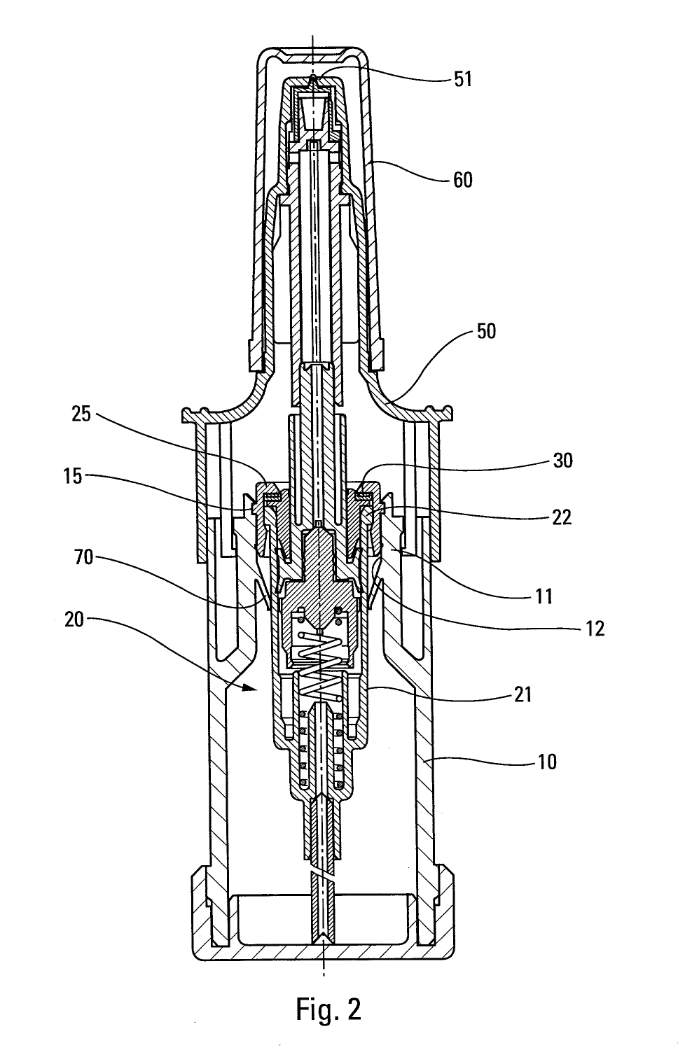

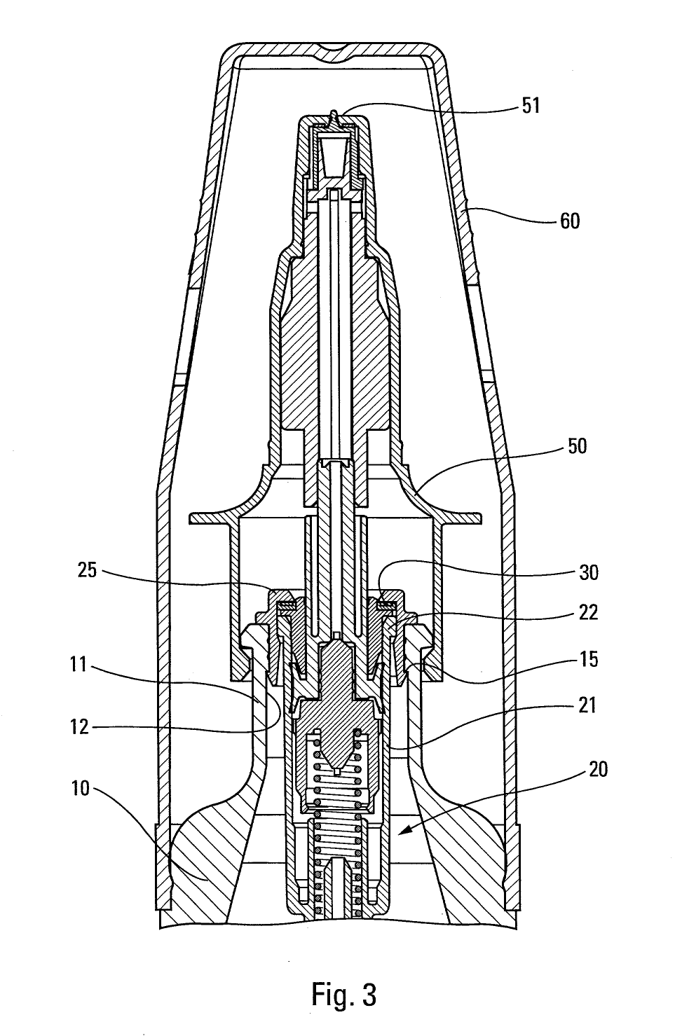

Referring to FIG. 2, an alternative embodiment is illustrated. In this alternative, the upper edge 22 of the pump body is fixed, notably snapped into a ring 25, which acts as a portion for fixing the pump 20. So, this is the ring 25 which is fixed on the internal wall 12 of neck 11 of tank 10. According to the invention, filter 30 is positioned between the upper edge 22 of the pump body 21 and said fixing ring 25, optionally with insertion of a ferrule. Fixing of ring 25 in the internal wall 12 of the neck 11 of tank 10 may be achieved either by a tight fit or by snapping, as illustrated in FIGS. 2 and 3. FIG. 2 shows a first alternative embodiment of this snapping of ring 25 into the neck of the tank, where the internal wall 12 of neck 11 includes a peripheral groove 15 into which a matching rib of ring 25 will snap. In the example of FIG. 3, the internal wall 12 of neck 11 includes a shoulder 15 which enables said fixing ring 25 to snap on.

In all cases, the dispensing unit, in this case the pump, is directly fixed on the internal wall 12 of neck 11 of the tank 10. Also, filter 30 for the venting air is always positioned at said fixing portion, which in the first embodiment is formed by the upper edge 22 of the pump body, and in the second and third embodiments is formed by ring 25. This guarantees a secure fixing, without requiring the use of an external ring with the drawbacks which this involves, and ensures a seal and perfect filtering at each actuation of the pump because of the position of filter 30, which also acts advantageously as a gasket. Optionally, if necessary, as illustrated in FIG. 2, the device may further include sealing means 70, called a sock, which serves as seal for the product between the neck and the pump body, while allowing the penetration of venting air into the tank, of course after its having passed through said filter 30.

Although the present invention was described with reference to three advantageous embodiments of the latter, it is not limited by the illustrated examples and one skilled in the art may add any changes without departing from the scope of the present invention as defined in the appended claims.

What is claimed is:

1/ A dispensing device for a fluid product including a product tank (10) comprising a neck (11) defining an internal wall (12), and a pump (20), fixed to said neck (11) of tank (10), wherein the device includes air venting and a filter (30) for venting air, characterized in that said pump (20) include a fixing portion (22, 25) which is fixed on the internal wall (12) of said neck (11) of tank (10), wherein said filter (30) is fixed on said fixing portion (22, 25).

2/ The device according to claim 1, wherein the pump (20) includes a body (21) comprising an upper edge (22) which forms said fixing portion (22), so that said body (21) is directly fixed onto the internal wall (12) of neck (11) of tank (10), wherein said filter (30) is positioned between said upper edge (22) of the body (21) and said neck (11) of the tank (10).

3/ The device according to claim 1, wherein the upper edge (21) of body (21) is fixed, preferably snapped into a ring (25) forming the fixing portion (25), wherein said ring (25) is fixed on the internal wall (12) of neck (11) of tank (10), said filter (30) is positioned between said upper edge (22) of the body (21) and said ring (25).

4/ The device according to claim 1, wherein the fixing portion (22, 25) of body (21) is tightly fitted into the neck (11) of tank (10).

5/ The device according to claim 1, wherein the fixing portion (22, 25), of body (21) is snapped into a fixing profile (15) provided in the internal wall (12) of the neck (11) of tank (10).

6/ The device according to claim 5, wherein said fixing profile (15) of neck (11) of tank (10) includes a groove or a shoulder for snapping on.
